(19) United States
(12) Patent Application Publication
(10) Pub. No.: US 2009/0129402 A1
(43) Pub. Date: May 21, 2009

(54) Method and System For Scheduling Multimedia Shows

(75) Inventors: Matthew Moller, San Francisco, CA (US); David M. Parrish, San Francisco, CA (US); Allen Miller, San Ramon, CA (US); Gianluca Macciocca, San Francisco, CA (US)

Correspondence Address: MARTINE PENILLA & GENCARELLA, LLP, 710 LAKEWAY DRIVE, SUITE 200, SUNNYVALE, CA, 94085, US

(73) Assignee: Simple Star, Inc.

(21) Appl. No.: 11/944,049

(22) Filed: Nov. 21, 2007

(51) Int. Cl. H04L 12/43

(52) U.S. Cl. 370/458

(57) ABSTRACT

A method and system for scheduling multimedia shows have been disclosed. According to one embodiment, a computer implemented method comprises receiving digital content to be used in a multimedia show, the digital content including digital photographs, digital video, and digital music. One or more categories associated with the digital content are determined. One or more cable network destinations that are available for the multimedia show are determined. Destination and category pairs are generated from the one or more categories and the one or more cable network destinations. One or more time slots are determined that are available for the digital content.

### TECHNICAL FIELD

The field of the invention relates generally to computer systems and more particularly relates to a method and system for scheduling multimedia shows.

### BACKGROUND

For many years, people have collected photographs and placed them in physical albums in order to preserve and share them with other people. In recent years, with the advent of digital photography, photographs are taken and stored on personal computers and other storage devices. Digital photographs can be burned onto DVDs and CD-ROMs and shared with others.

Many digital cameras allow users to connect the camera to a television to display the digital photographs stored in the camera. Some services, such as those offered by KODAK, allow people to receive CD-ROMs with digital images stored on them, whether taken with a digital camera or a film based camera. In addition, some DVD players could read DVDs and CD-ROMs such that digital photo albums can be watched on a television.

Even more recently, technology has been developed that allows digital photographs to be uploaded to servers on the Internet and shared with other people. Websites such as OFOTO, FLICKR, SHARPCAST, and SNAPFISH have provided various ways to organize and collect digital photographs.

Digital photography has also become more and more ubiquitous in that mobile phones and other handheld devices are being sold with integrated digital cameras. Accordingly, more and more photographic content is available in digital form for which new distribution mechanisms need be developed.

### SUMMARY

A method and system for a method and system for scheduling multimedia shows are disclosed. According to one embodiment, a computer implemented method comprises receiving digital content to be used in a multimedia show, the digital content including digital photographs, digital video, and digital music. One or more categories associated with the digital content are determined. One or more cable network destinations that are available for the multimedia show are determined. Destination and category pairs are generated from the one or more categories and the one or more cable network destinations. One or more time slots are determined that are available for the digital content.

The above and other preferred features, including various novel details of implementation and combination of elements, will now be more particularly described with reference to the accompanying drawings and pointed out in the claims. It will be understood that the particular methods and systems described herein are shown by way of illustration only and not as limitations. As will be understood by those skilled in the art, the principles and features described herein may be employed in various and numerous embodiments without departing from the scope of the teachings herein.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a block diagram of an exemplary system for delivering multimedia shows over a cable network, according to one embodiment;

FIG. 2 illustrates an exemplary computer architecture for use with the present system, according to one embodiment;

FIG. 3 illustrates a flow diagram of an exemplary process for delivering multimedia shows over a cable network, according to one embodiment;

FIG. 4 illustrates a block diagram of an exemplary system for delivering multimedia shows over a cable network, according to another embodiment;

FIG. 5 illustrates a block diagram of an exemplary system for delivering multimedia shows using destinations and categories associated with multimedia shows, according to one embodiment;

FIG. 6 illustrates a block diagram of an exemplary multimedia show scheduling process, according to one embodiment;

FIG. 7 illustrates an exemplary playlist, according to one embodiment;

FIG. 8 illustrates an exemplary video on demand XML file, according to one embodiment;

FIG. 9 illustrates a block diagram of an exemplary multimedia show scheduling process, according to one embodiment;

FIG. 10 illustrates a block diagram of an exemplary multimedia show scheduling process, according to one embodiment;

FIG. 11 illustrates a diagram of an exemplary multimedia show scheduling process, according to one embodiment; and

FIG. 12 illustrates a block diagram of an exemplary multimedia show approval process, according to one embodiment.

### DETAILED DESCRIPTION

A method and system for scheduling multimedia shows are disclosed. According to one embodiment, a computer implemented method comprises receiving digital content to be used in a multimedia show, the digital content including digital photographs, digital video, and digital music. One or more categories associated with the digital content are determined. One or more cable network destinations that are available for the multimedia show are determined. Destination and category pairs are generated from the one or more categories and the one or more cable network destinations. One or more time slots are determined that are available for the digital content.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

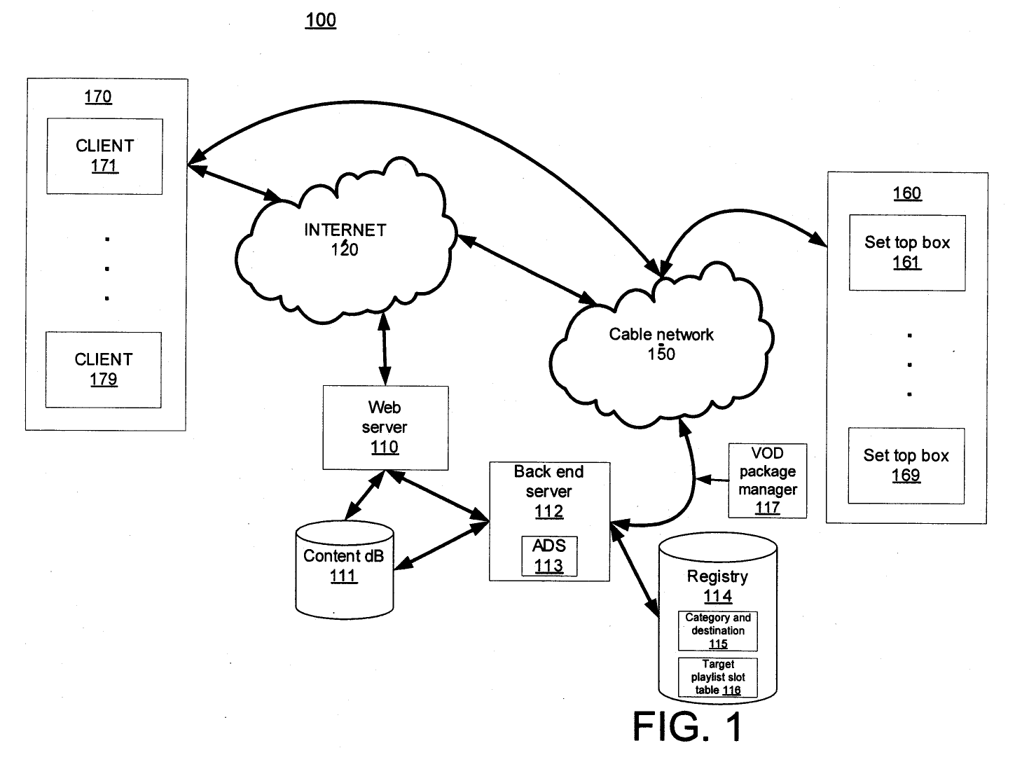

FIG. 1 illustrates a block diagram of an exemplary system 100 for delivering multimedia shows over a cable network, according to one embodiment. According to one embodiment, a multimedia show is a collection of digital photos and videos combined with title credits, captions, transitions, special effects, animations, and a musical soundtrack. Although described with respect to a cable television system, the present system and methods may also be used with wireless systems, Internet, and other similar networks. System 100 includes one or more clients 170 that are connected to a data network, such as Internet 120. According to one embodiment, network 120 is described as being the Internet, alternatively, the network 120 may be a Wide Area Network (WAN), a Local Area Network (LAN), or any other system of interconnections enabling two or more devices to exchange information. Further, the network 120 may include a wireless network, such that one or more of clients 110 or 160 may be wireless devices. Clients 170 may also access the Internet through cable network 150, for example through a cable modem.

Clients 170 are computers through which users upload digital content, including photographs and videos to web server 110. Web server 110 provides an interface for users to provide content and information to be saved in content database 111. The interface may be accessed via a website, or through an application running on a client 170. One or more of clients 170 may allow network access via a web browser such as MICROSOFT'S INTERNET EXPLORER, NETSCAPE BROWSER, MOZILLA, FIREFOX, or the SAFARI browsers that support HTML and JavaScript. Additionally, clients 170 may be mobile devices, such as videophones, laptops, smart phones, mobile phones, PDAs, game devices such as the PSP manufactured by Sony Electronics, multimedia devices such as iPods and iPhones manufactured by Apple Computers of Cupertino, Calif., or similar devices. Clients 170 may also fixed devices such as set top boxes, desktop computers, media recorders such as those manufactured by TiVo, Inc. of Alviso, Calif., game devices such as the XBox manufactured by Microsoft, Corp. of Redmond, Wash. or similar devices.

Web server 110 uses any one of a number of protocols and/or applications including HyperText Transfer Protocol (HTTP), File Transfer Protocol (FTP), Internet Relay Chat (IRC), etc., via a TCP/IP connection (not shown in this view) or other similar connection protocols. The operating system may be Windows®, LINUX, SUN Solaris®, Mac OS, Tiger, or other similar operating system. It uses processing logic, tools and databases and is built using a combination of technologies such as those from Apache Software (www.apache.org) such as Tomcat servers; Java based technologies such as J2EE, EJB, JBOSS, JDBC; and/or databases such as MySQL with content database 111.

Content database 111 stores images such as digital photographs in JPEG format, although other formats are also supported. Metadata files are also stored and maintained in content database 111 in the form of XML files. Video is stored in content database 111 in FLASH VIDEO format, although MPEG is also supported. Music and clipart is stored in FLASH VIDEO format, although other formats are also supported. The contents of content database 111 are used to generate a multimedia show that is ultimately viewable through cable network 150 via a set top box 160.

Back end server 112 interfaces with web server 110, content database 111, and registry 114 to process the digital content and information on content database 111 so that it can be provided to cable network 150. Back end server 112 also contains an AirDate Scheduler (“ADS”) 113 which schedules multimedia shows for playback on TV, provides an interface for users to perform various functions, and interprets and arbitrates multimedia show TV rules. Cable network 150 includes a cable television headend that is a master facility for receiving television signals for processing and distribution over cable network 150. The cable TV headend will normally have several large FSS-type television receive-only satellite television dishes for reception of cable/satellite TV networks such as ESPN, CNN, or HBO; a dedicated, non-movable dish is required for each satellite that the cable TV utility wishes to receive cable channels from for distribution over its system. For reception of signals from several adjacent satellites, a larger non-parabolic multi-satellite dish (such as the Torus or Simulsat) that can see up to 3 or more satellites is often used. Many digital cable systems use services like HITS (“Headend In The Sky”, a unit of Comcast), which carry hundreds of channels on just a few satellites; this is commonly used by small systems to expand service without adding expensive new dishes or other equipment.

Cable network 150 also includes a Video On Demand (“VOD”) system that allows users to select and watch video content over a network as part of an interactive television system. VOD systems either stream content, allowing viewing in real time, or download it in which the program is brought in its entirety to a set-top box 160 before viewing starts. Often, VOD encompasses a broader spectrum of delivery devices, referring not only to set-top-boxes 160 but also computers 170, mobile phones and indeed any system that can receive on-demand audio-visual content over a network such as cable network 150.

Cable network 150 communicates with set top boxes 160 to deliver multimedia shows based on the content stored in content database 111. Set-top box 160 is a device that connects to a television and cable network 150, and turns the signals provided by cable network 150 into content then displayed on the screen.

System 100 may also include other supporting computing software and hardware, for example, additional website servers, databases, computers, and user interface servers.

In one embodiment, client 171 submits certain digital content for one or more destinations, and/or one or more categories, and/or one or more desirable time period. Client 171 may also like to receive available time periods for the requirements just submitted. The web server 110 receives the request and communicates with the back end server 112. The ADS 113 in turn communicates with the registry 114 that stores available target slots for destinations and categories. The available target slots are sent back to the back end server 112 then to the web server 110. Client 171 can view the potentially available target slots and choose the more desirable ones from them. This puts a hold on that target slot for the digital content submitted by this client 171. This hold can be either confirmed or rejected later when the actual scheduling happens for the digital content. If client 171 has specified the desirable time period, the system can check to see if any potentially open target slot meeting the criteria exists and feed the information back to client 171.

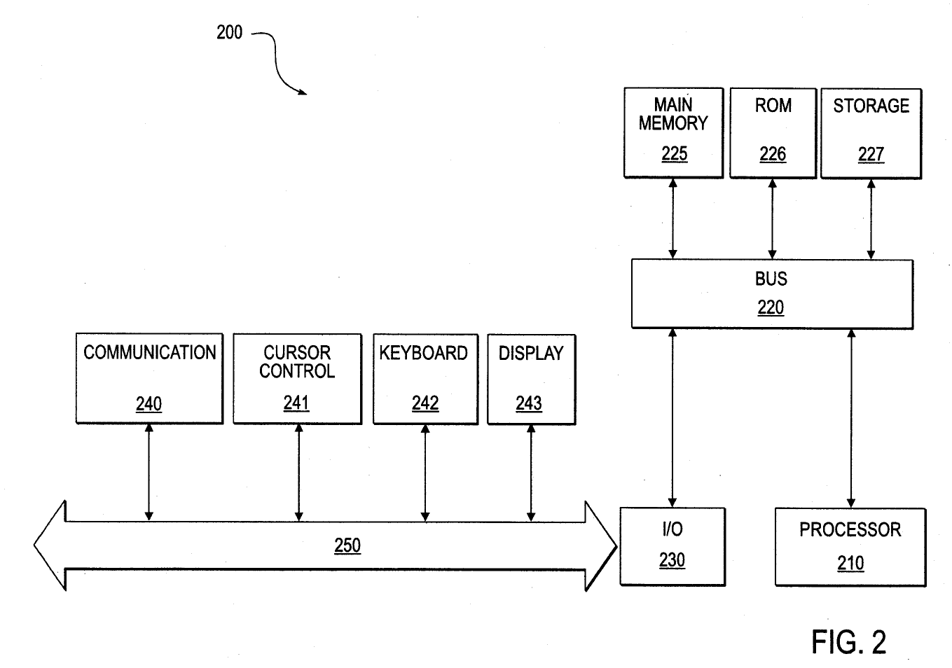

FIG. 2 illustrates an exemplary computer architecture for use with the present system, according to one embodiment. Computer architecture 200 can be used to implement a client 170, or a server 110 and 112 of FIG. 1. One embodiment of architecture 200 comprises a system bus 220 for communicating information, and a processor 210 coupled to bus 220 for processing information. Architecture 200 further comprises a random access memory (RAM) or other dynamic storage device 225 (referred to herein as main memory), coupled to bus 220 for storing information and instructions to be executed by processor 210. Main memory 225 also may be used for storing temporary variables or other intermediate information during execution of instructions by processor 210. Architecture 200 also may include a read only memory (ROM) and/or other static storage device 226 coupled to bus 220 for storing static information and instructions used by processor 210.

A data storage device 227 such as a magnetic disk or optical disc and its corresponding drive may also be coupled to computer system 200 for storing information and instructions. Architecture 200 can also be coupled to a second I/O bus 250 via an I/O interface 230. A plurality of I/O devices may be coupled to I/O bus 250, including a display device 243, an input device (e.g., an alphanumeric input device 242 and/or a cursor control device 241).

The communication device 240 allows for access to other computers (servers or clients) via a network. The communication device 240 may comprise a modem, a network interface card, a wireless network interface or other well known interface device, such as those used for coupling to Ethernet, token ring, or other types of networks.

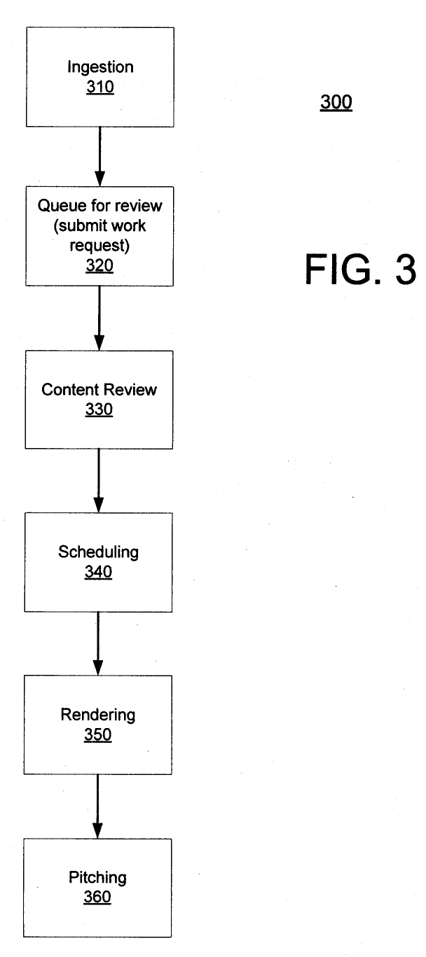

FIG. 3 illustrates a flow diagram of an exemplary process 300 for delivering multimedia shows over a cable network, according to one embodiment. System 100 operates to ingest digital content, including digital photographs and information relating to the desired multimedia show. (310) The digital content is transferred from clients 170 to the web server 110 via network 120. The digital content is then placed into a queue for review and for rendering. (320) The digital content is reviewed, either through an automated process executing on web server 110 or back end server 112, or through human review. (330) The digital content may be reviewed for any criteria, including to filter adult content. If the digital content is not approved, an e-mail notification is generated and automatically sent to the user. If the digital content is approved, then the content is assigned a scheduled date and time for broadcast. (340) The content is then processed for rendering on cable network 150. (350) Finally, the content is transmitted onto the cable network, a process also referred to as rendering. (360)

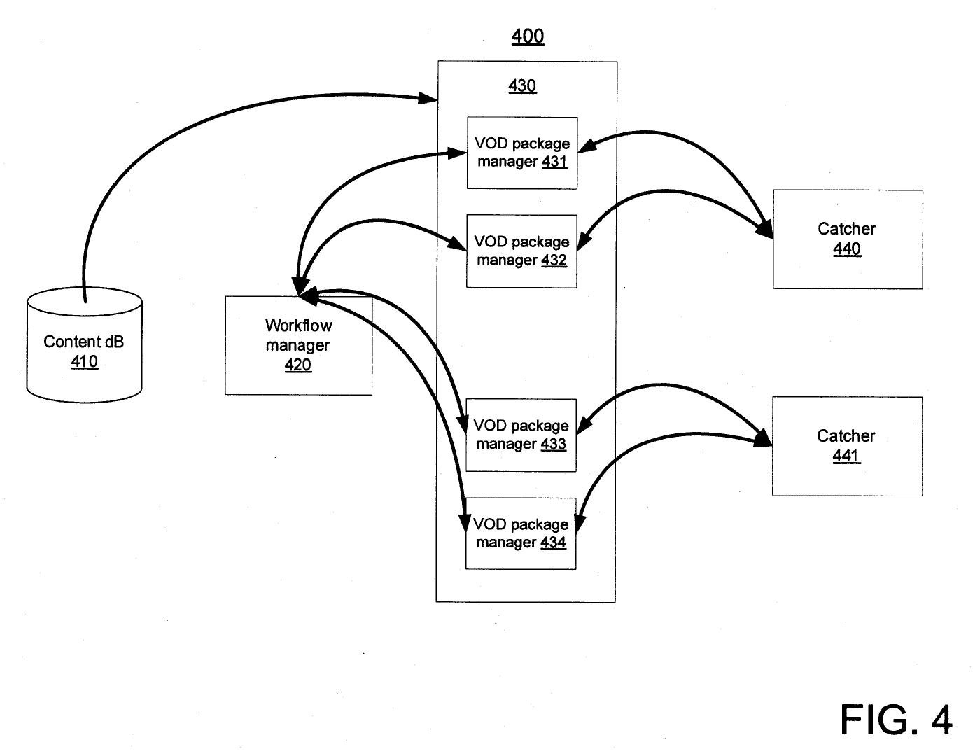

FIG. 4 illustrates a flow diagram of a block diagram of an exemplary system 400 for delivering multimedia shows over a cable network, according to another embodiment. System 400 includes a content database 410, that may be content database 111 according to one embodiment. System 400 may be physically located in different places, for example, in content database 111, back end server 112, or cable network 150 of FIG. 1. A bank of VOD package managers 430 transform the content in content database 410 into a multimedia show, a process also referred to as rendering. One or more VOD package managers 431-434 may be physically located in different places. These VOD package managers may be the VOD package manager 117 in one embodiment. VOD package managers 431-434 may be put to different groups to serve particular geographic areas or particular cable networks 150. For example, VOD package manager 432 may serve a cable network located in Hawaii, whereas renderer 433-434 may together serve a cable network located in Staten Island.

VOD package managers 430 are transcoding appliances that include a playback engine. They request instructions (e.g. a metafile) for generating multimedia shows and execute the instructions to create the multimedia shows by converting images into a video file (e.g., animation). More particularly, each VOD package manager 430 subscribes to JMS (Java Messaging Service) queues that relate to the destination and/or on a particular kind of multimedia shows that it is responsible for processing. JMS queues are provided by the workflow manager 420 and contain messages for pitching or rendering, also known as pitch directives and render directives in one embodiment. Separate queues may be used for render directives and pitch directives in one embodiment. Render directives reference the source media and playback instructions (in the form of an XML file) contained in the content database 410. Playback instructions include a manifest of content, music, transitions, special effects, etc. The VOD package managers 430 process the playback instructions to produce a cable-compatible media file including video and audio. When a VOD package manager 430 finishes processing the playback instructions, it notifies the workflow manager 420, that the multimedia show is complete. Pitch directives include the rendered data location, the destination address of the catcher, and other attributes necessary for the VOD system of cable system 150. VOD package managers 430 respond to pitch directives on the JMS queues and transmit VOD packages to specified catchers 440, 441 of a VOD system of cable system 150. VOD package managers 430 thus perform both the rendering and the pitching functions in this embodiment.

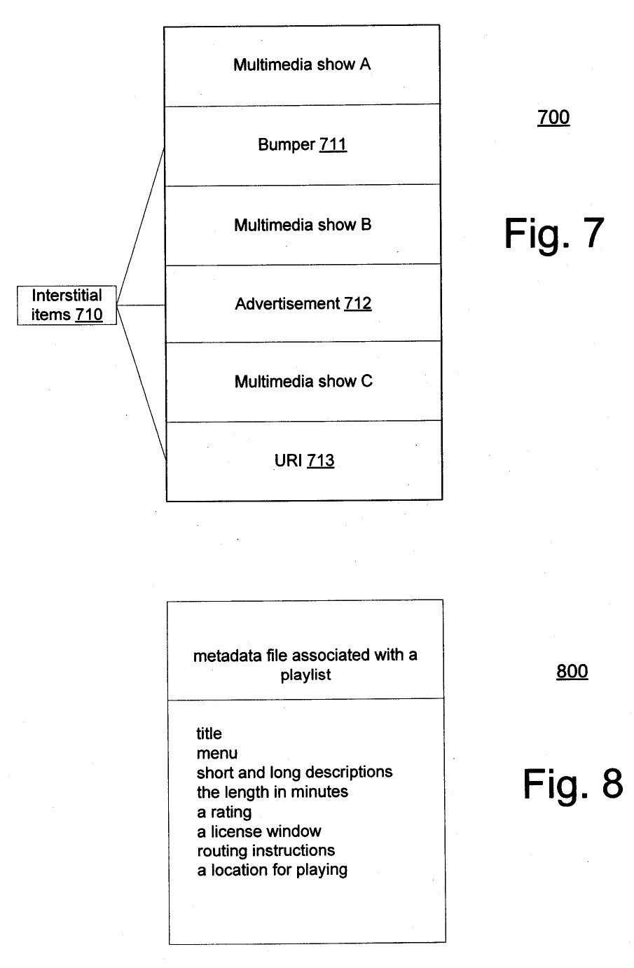

Workflow manager 420 and VOD package managers 430 may be instantiated on back end server 112, according to one embodiment. VOD package managers 430 may also be instantiated on a system between the back end server 112 and the cable network 150, according to another embodiment. The back end server 112 generates a unique VOD XML file for each playlist and pass the VOD XML files to VOD package managers 430. Each playlist may contain one or more multimedia shows. The playlist may also contain one or more items which can be a Uniform Resource Identifier (“URI”), a bumper which is a brief spot of video that announces “what's coming up next” in one embodiment, an advertisement, branding or sponsorship material, or anything else viewable in a webpage. The items in the playlist can also be a place holder for the above listed items. In one embodiment, a playlist contains a place holder for advertisements, which allows the local broadcaster to dynamically insert their advertisements into the playlist. The playlist is a combination of the items which are played back seamlessly as a whole. In one embodiment as shown in FIG. 7, a playlist contains multimedia show A, a bumper 711, multimedia show B, an advertisement 712, multimedia show C, and a URI 713. FIG. 8 shows that each VOD XML file contains VOD metadata including a title, menu, short and long descriptions, the length of the show in minutes, a rating, a license window (including a start and end date), routing instructions and a location for playing (e.g., Hawaii cable system, Staten Island cable system). According to one embodiment, the VOD XML file is related to an ADI file as defined by Cable Labs.

Workflow manager 420 also provides management functionalities to ensure that operational constraints are followed. The operational constraints are often imposed by the cable network 150. For example, cable network 150 may specify a maximum amount of space for multimedia shows based on time, data size and/or the number of target slots for playback on the VOD system. In addition, cable network 150 may impose a time window in which all multimedia shows may be transmitted to the catchers 440, 441 (e.g., 1 a.m. to 5 a.m.). Another constraint may be the times at which the particular multimedia show may be broadcast on-air (e.g., the number of days the multimedia show is available on the VOD system).

Once a multimedia show has been transmitted to catchers 440, 441, the multimedia show may have one of three states: pending, on-air, or off-air. As multimedia shows are continuously being produced and submitted to catchers 440, 441, a process for queuing the flow of multimedia shows exists. In one embodiment, the VOD system controls the on-air or off-air time of multimedia shows depending on when the license window of multimedia shows starts and ends. Multiple categories of multimedia shows are maintained. Each category may have a number of simultaneous multimedia shows that may be available. Multimedia shows for each category are queued and staged pending broadcast. A first in first out process may be used where each multimedia show is guaranteed a minimum amount of time to be available on cable system 150. A gating module controls the transfer of the queued multimedia shows to the playing state when the license period of the multimedia show starts, which is indicated in the VOD XML file in one embodiment. When the license period of the multimedia show ends, as indicated in the VOD XML file in one embodiment, the cable system 150 automatically terminates the multimedia show and deletes the content.

Workflow manager 420 also includes a mechanism to extend the license period of a particular multimedia show, by modifying the XML file accompanying the MPEG file. According to one embodiment, a duplicate multimedia show is generated with a new XML file that extends the license period.

The author of the multimedia show is automatically contacted and notified of the date and time when the multimedia show will be available on the cable system 150.

According to one embodiment, workflow manager 420 includes a roll-up mechanism that aggregates all multimedia shows in a particular category. In addition, interstitials are inserted between each multimedia show, where the interstitials may be advertisements or other video content. The roll-up mechanism renders a single multimedia show and a corresponding XML file with license information.

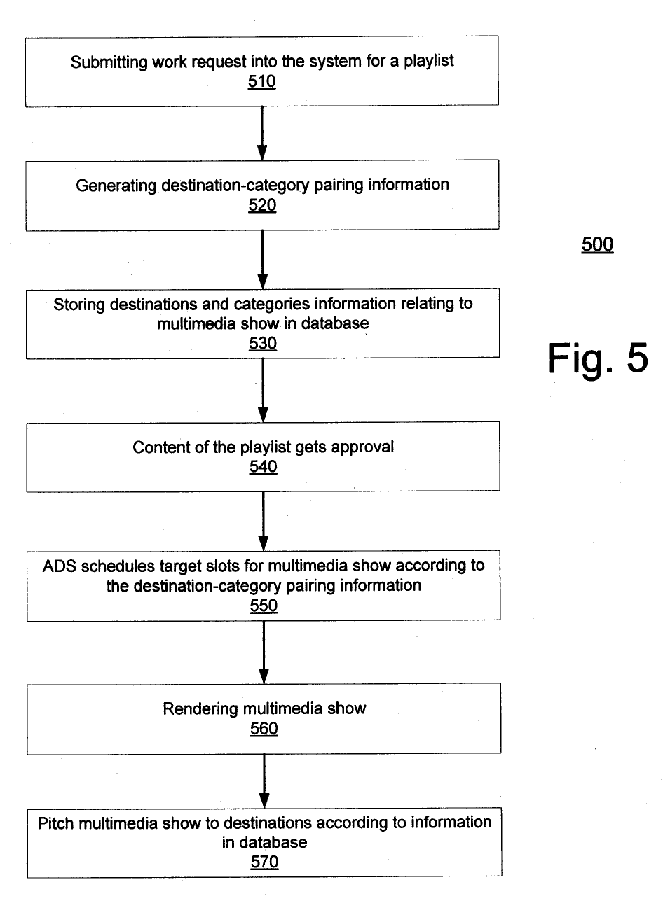

FIG. 5 illustrates a flow diagram of an exemplary multimedia show delivering process 500 using destination-category pairing information associated with the multimedia shows over a cable network, according to one embodiment. The delivering process provides flexible scheduling for multimedia shows. System 500 receives work requests for content that are stored in the content database 111 in one embodiment. (510) Work requests are stored in a queue for review. Each work request contains one or more playlist and one or more target requests, according to one embodiment. One playlist is to be delivered to one or more targets thus it corresponds to one or more target requests. Each target request contains one category, one destination, or both. The category information is a grouping of multimedia shows related to a particular genre. The destination information describes to which TV system or systems the multimedia show is to be delivered.

System 500 gets the destination and the category information associated with each target request in the work request. If one target request has both destination and category specified, the system will simply generate this one pair of destination-category for this target request. If one target request has only destination information, the system will look up in a database to pull out all the categories associated with this destination. This database could be the registry 114, and the Destination and Category table 115 stores the destination and category association information in one embodiment. If one target request has only category information, the system looks up in a database to pull out all the destinations associated with this category. Once the system 500 has both destination and category information for each target request in the work request, it generates destination-category pairs associated with the playlist in the work request. (520) The particular destination-category pairing information associated with the playlist is stored in the target playlist slot table 116 in a back end database, which may be the registry 114, according to one embodiment. (530) The content of the playlist then needs to get approved, for adult content in one embodiment. (540)

ADS 113 schedules target slots for the playlist according to the destination-category pairing information. For each destination-category pair of the playlist, either category or the destination is the dominant element. The schedule rules of the dominant element are used by ADS 113 to determine the schedule of the playlist. (550) One playlist VOD package is generated for each destination-category associated with the playlist in one embodiment. Each VOD package includes the video rendered from the playlist and the associated VOD XML file. After the schedule is determined, the video data for each playlist VOD package is generated, a process also referred to as rendering. Each VOD package includes the video rendered from the playlist and the associated VOD XML file. (560) Finally, VOD metadata XML is generated for each VOD package. The settings in each VOD metadata include a license window defined by the associated target slot and corresponding schedule rules. The complete VOD packages are then transmitted onto one or more cable networks according to the associated destination-category pair information stored in the registry 114; this process is also referred to as pitching. (570) The mode of transfer would normally be FTP. Other transfer modes could also be used.

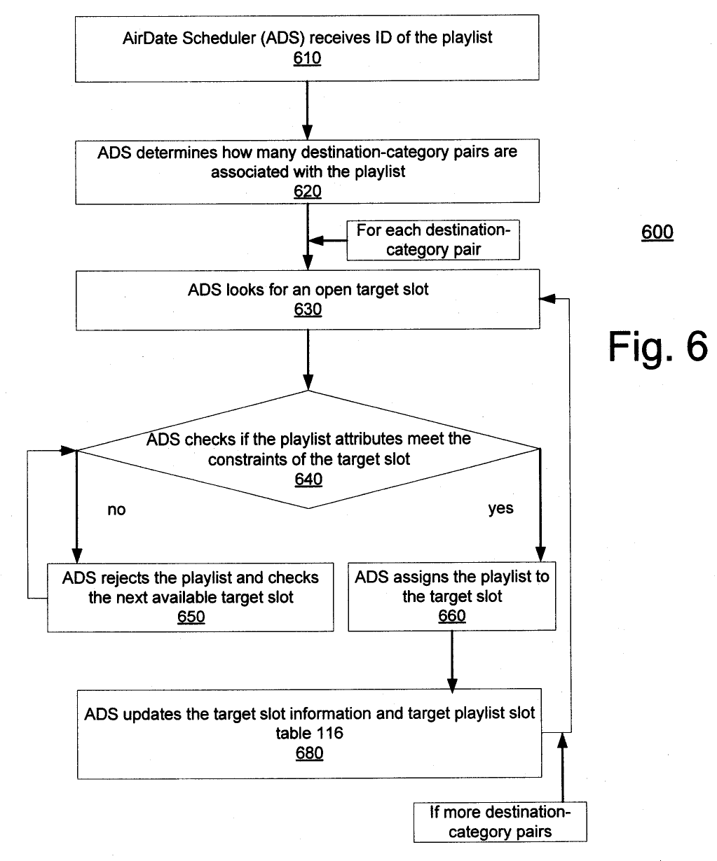

FIG. 6 illustrates a block diagram of an exemplary multimedia show scheduling process. 600, according to one embodiment. For each playlist whose schedule needs to be determined, ADS 113 receives the ID of the playlist. (610)

ADS 113 determines how many destination-category pairs are associated with the playlist. (620) For each destination-category pair associated with a playlist, ADS 113 looks for an open target slot. (630) A target slot contains a collection of things that are made available on-air at a given time and is associated with a destination-category pair. The target slot information may be contained in the target request. Once an open target slot is found, ADS 113 checks if the playlist has been approved before the cutoff time of the target slot. If not, ADS 113 will go for the next available target slot. If yes, ADS 113 checks the constraints of the target slot against the playlist's attributes. (640) In one embodiment, the constraints include playlist count, single playlist run time, total run time, total size, total pitch size, total destination size, total destination time, and pitch category count. If the constraints are not met, ADS 113 rejects the playlist for this target slot and repeats the process 640 until it determines the next available target slot. (650) In one embodiment, a particular target slot holds 10 playlists. By way of example, one playlist has met the cutoff time but is the 11th playlist to wait to get into this target slot. It therefore cannot meet the constraints and will be rejected for this target slot. This process repeats until all the constraints are met and ADS 113 assigns this playlist to the qualifying target slot. (660)

ADS 113 then updates the target slot information to include the information of the newly scheduled playlist. ADS 113 also updates the target playlist slot table 116 in registry 114 in one embodiment.

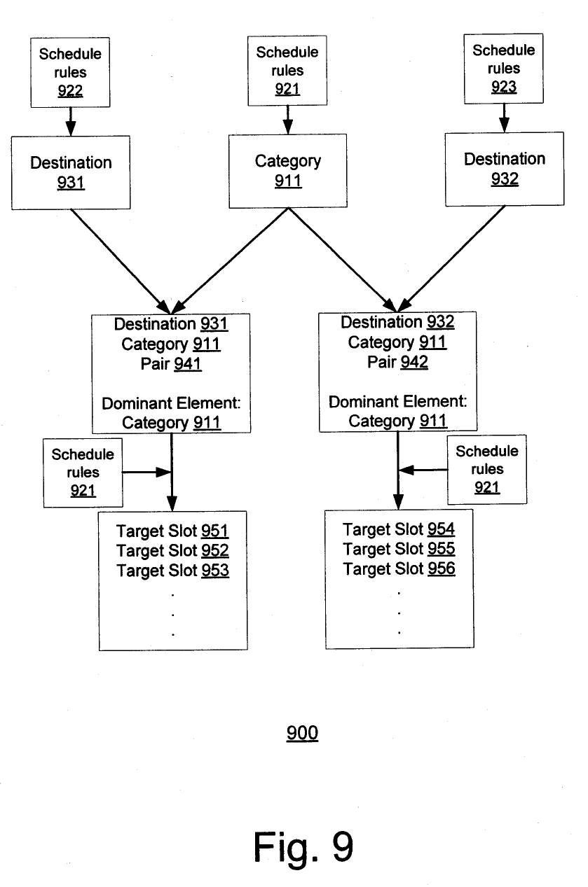

FIG. 9 illustrates a diagram of an exemplary multimedia show scheduling process 900 using destination-category pairing information associated with the playlist over a cable network, according to one embodiment. As discussed above, one playlist may be associated with one or more destination-category pairs. In one embodiment, the playlist is in a category “surfing” 911, and has two destinations: travel channel in Hawaii 931, and entertainment channel in Staten Island, N.Y. 932. For each destination-category pair: “surfing-travel Hawaii” 941 and “surfing-entertainment Staten Island” 942, the dominant element is the category “surfing” 911 in this embodiment. Therefore the schedule rules 921 of the category “surfing” 911 are used by ADS 113 to determine the target slot for the playlist. For the first destination-category pair, ADS 113 checks the first available target slot from a list of target slots 951-953, if target slot 951 does not work, ADS 113 goes for the next available target slot until it finds a target slot for the destination-category pair. In the example given above, since there are two destination-category pairs, ADS 113 repeats the target slot determining process twice. For the second destination-category pair, ADS 113 picks a target slot from the target slots list 954-956 that are potentially available for the second destination-category pair.

ADS 113 also checks if other playlists which have the category “surfing” 911 associated with them in their destination-category pairs. For all other playlists that have a “surfing” category, and the category is the dominant element, ADS 113 determines the target slots for all such playlists.

In another example, multiple categories of “surfing”, “biking”, and “water skiing” are created for the destination of sports channel in Hawaii. The destination is the dominant element for the destination-category pairs of “surfing-sports Hawaii”, “biking-sports Hawaii”, and “water skiing-sports Hawaii”. The schedule rules of the destination thus are used to determine the target slots for the playlist.

For other playlists targeted at the same destination, the schedule rules of the destination are also used to determine the target slots if the destination is the dominant element in their destination-category pairs. The destination-category pairing and the dominant element's schedule rules thus allow flexible scheduling of multimedia shows.

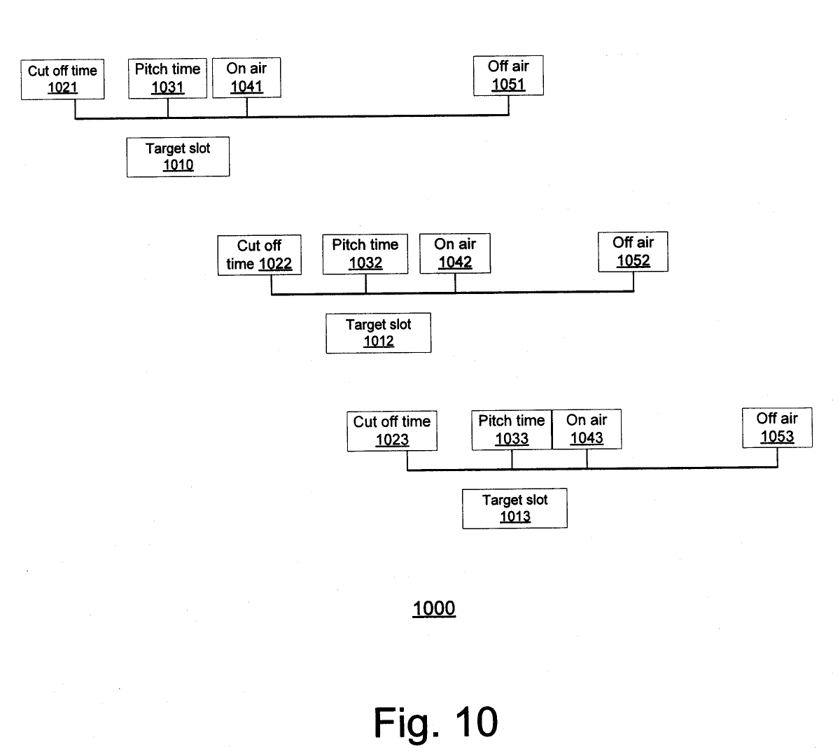

FIG. 10 illustrates an exemplary multimedia show scheduling process 1000 over a cable network, according to one embodiment. Each target slot 1011-1013 has a cut off time 1021-1023 to receive playlists waiting to be scheduled for this target slot. For each playlist to be scheduled, ADS 113 looks for the next available target slot. ADS 113 then populates the target slot for the playlists that have met the cutoff time. Video for the associated VOD packages is then rendered. Prior to pitching, VOD metadata xml is generated for each VOD package with a license window that is set to start at the target slot on-air time 1041-1043 and is set to end according to the rules of the schedule set. In one embodiment the off-air time in the license window is set to the on-air time of the target slot plus a duration time specified in the associated schedule set. When the pitch time 1031-1033 for a target slot is reached, the VOD package manager 117 associated with the destination of the target slot is instructed by the backend server 112 to pitch the VOD packages to the content catcher associated with the destination of the target slot. When the on-air time 1141-1143 of the target slot is reached, the VOD packages scheduled for that target slot can be requested and viewed on-air as their license windows will then be on-air. The VOD packages scheduled for this target slot will be available for view until their off-air time is reached. This process is repeated for the next target slot. The off-air time of VOD packages that have been pitched can extend beyond the on-air time of the subsequent target slot to provide more flexible choices to clients. The license window for VOD packages in a target slot can differ depending on attributes of the playlist being pitched. A newly pitched playlist may have a longer license window than an autofilled playlist for example.

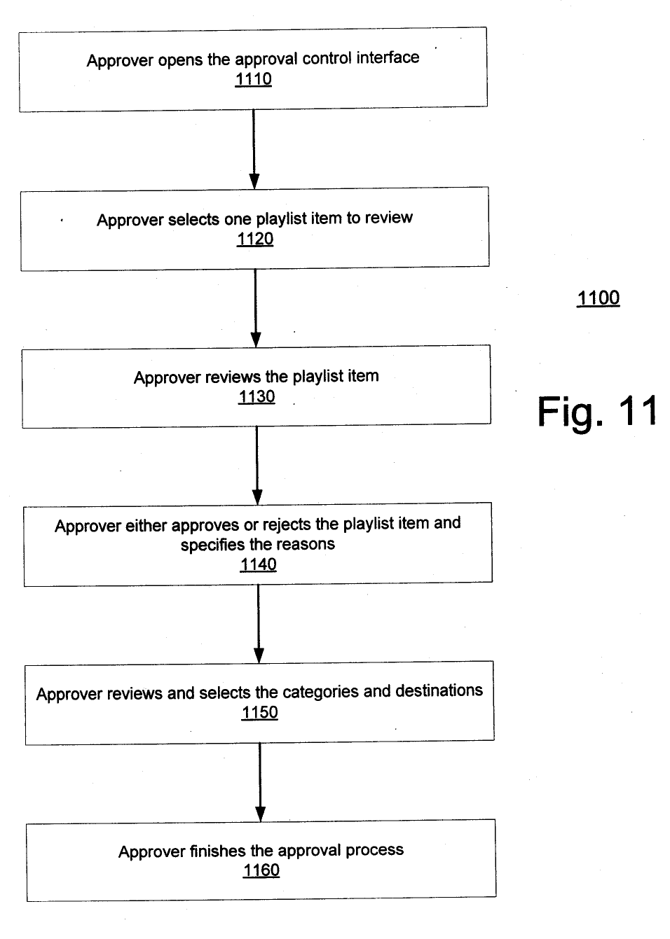

FIG. 11 illustrates a block diagram of an exemplary multimedia show approval process 1100, according to one embodiment. The approval process provides flexible review methods for an approver as well as flexible automatic scanning by the system. The approver of the content of the playlists opens a graphic interface for the approval process and can choose to accept the approval task for a playlist. (1110) Typically the approver reviews one playlist at a time in one embodiment. The graphic interface displays all relevant details associated with the playlist. In one embodiment, such details include broadcaster name, destination, category, type, title, and duration of the playlist.

Since one playlist may contain multiple items, the approver can choose one item at one time to review from an item list, in one embodiment. (1120) In another embodiment, the approver can choose to review all items of one playlist which are displayed in sequence in one page. This embodiment optimize the process by saving the approver from clicking through each playlist item and reviewing each individually.

The approval process may automatically scan, detect, and highlight profane or suggestive words contained in the title of a playlist item or a playlist. The approval process may also automatically process the playlist items to highlight portions with potential problems, for example, nudity or cursing. The National Television System Committee (“NTSC”) Color Safe algorithm may be applied to photos and videos before they are displayed in the approval screen. This application allows the approver to perform quality control and review whether there are offensive details that only show up when processed in this manner.

The approver can review the content of the item in its normal playback form or in a quick-review mode. (1130) In the quick-review mode, the review process provides the approver with all the photos, videos and text included in the playlist item in the form of thumbnails. The review process also provides all the information in the metadata files associated with the playlist item. The approver can review each thumbnail in its full size. In one embodiment, videos are enlarged in the quick-review mode. Videos can also be played back in its entirety, including associated audio. In another embodiment, rapid review is facilitated by providing quick tab-to-see option which allows the approver to quickly review all photos and videos. For even faster review, the approval process provides an accelerated playback mechanism which allows the approver to play back all media fully but at a higher than their original normal speed. In one embodiment, all photos are played back at 1 second duration rather than their variable duration determined when the multimedia show was generated. Videos and audios are played back at a accelerated speed in this mode. This allows more efficient review of content while keeping the content in context. In yet another embodiment, the approval process provides an interface for the approver to review audio files associated with photos or videos by displaying the music title and providing the ability to click and playback the music. The approver also reviews the rating criteria associated with each target request and applies appropriate screening to the content of the playlist item, according to one embodiment.

After the approver reviews the content, the approver can either accept or reject the playlist. The review process allows the approver to specify the reasons for acceptance or rejection. (1140) The system will also display the destination-category pairing information created by the system. The approver can thus optionally review and edit the categories and destinations information associated with the playlist. (1150) The approver can then officially finish the approval process for this playlist. (1160)

This approval process applies not only to a playlist item such as a multimedia show, but also other playlist items such as mixed-media files or multi-asset file formats.

In one embodiment, where the target request contains more than one destination and the broadcaster for each destination needs to approve the playlist independently, the approval process is broken down into separate sections for different broadcasters. For efficiency purposes, these separate sections can be condensed into one single screen.

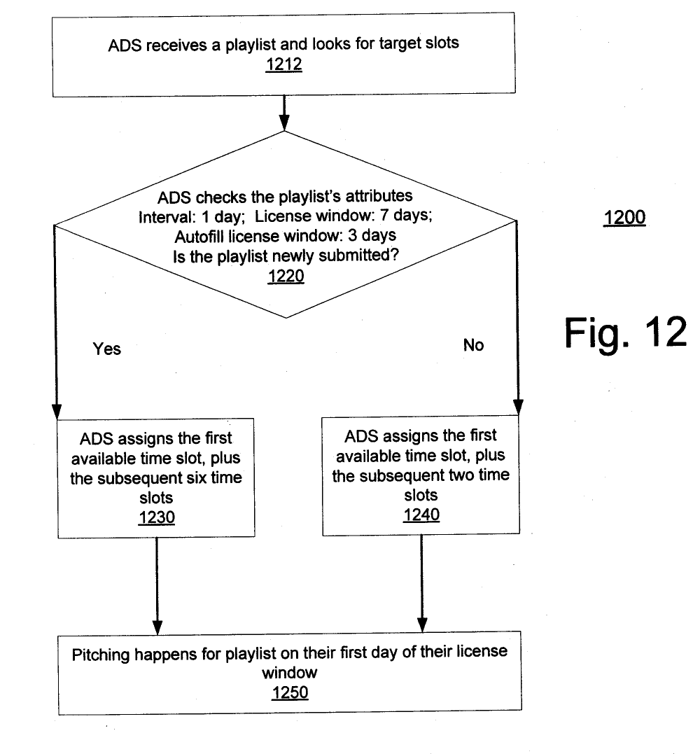

FIG. 12 illustrates a block diagram of an exemplary multimedia show scheduling process 1200, according to one embodiment. When the ADS 113 receives a work request for one playlist, it populates the target slots of all the destination-category pairs associated with the playlist. (1210) The playlist has attributes describing the interval it is to be pitched, duration of its license window, and duration of its autofill license window. In one embodiment, the interval to pitch a playlist is once a day, duration of its license window is 7 days, and its autofill license window is 3 days. This means the playlist will be pitched daily during its 7 days of license when it is newly scheduled, and will be pitched daily during its 3 days of autofill license window when it is autofilled. Different scheduling types can be used to schedule a playlist's pitching interval. In one embodiment, the schedule would be one of the following: specific week days, specific week day and times, specific month days, specific month day and times, specific dates, and specific dates and times.

ADS 113 checks this playlist's attributes in order to populate a target slot. (1220) For the example described above, ADS 113 assigns the first available target slot plus the subsequent six target slots for a newly submitted playlist. (1230) ADS 113 assigns the first available target slot plus the subsequent two target slots for an autofilled playlist. (1240) In one embodiment, pitching of the playlist only happens for playlists that are on the first day of their license window. (1250) The license window is determined by each broadcaster in the destination. It is stored in the VOD metadata file and can be extended by modification of the metadata file.

A method and system for scheduling multimedia shows have been described. It is understood that the embodiments described herein are for the purpose of elucidation and should not be considered limiting the subject matter of the present patent. Various modifications, uses, substitutions, combinations, improvements, methods of productions without departing from the scope or spirit of the present invention would be evident to a person skilled in the art.

We claim:

1. A computer-implemented method, comprising:
receiving digital content to be used in a multimedia show, the digital content including digital photographs, digital video, and digital music;
determining one or more categories associated with the digital content;
determining one or more cable network destinations available for the multimedia show;
generating destination and category pairs from the one or more categories and the one or more cable network destinations; and
determining one or more time slots available for the digital content.

2. The computer-implemented method of claim 1, further comprising providing the one or more time slots to a client before rendering the multimedia show; and
receiving a time slot selection from the client.

3. The computer-implemented method of claim 2, further comprising:
rendering the multimedia show;
notifying a workflow manager that the multimedia show has been rendered;
transmitting the multimedia show to the one or more cable network destinations for transmission on a VOD system, according to the one or more time slots and the one or more categories.

4. The computer-implemented method of claim 3, further comprising associating a state with the multimedia show, the state being one of pending, on-air, and off-air.

5. The computer-implemented method of claim 1, wherein an XML file includes a title, a menu, a short description, a long description, a length of the multimedia show, a rating, a license window, routing instructions and a location for playing.

6. The computer-implemented method of claim 3, further comprising queuing the multimedia show for review according to the one or more categories, and the one or more destinations.

7. The computer-implemented method of claim 3, further comprising queuing the multimedia show for availability on the VOD system according to one or more constraints, where the one or more constraints include a cut-off time for approving the multimedia show, a maximum amount of space for the multimedia shows based on time, data size and the number of slots for playback on the VOD system.

8. The computer-implemented method of claim 2, further comprising queuing the multimedia show for availability on the VOD system according to one or more constraints, where the one or more constraints include a time window in which the multimedia show may be transmitted to the cable system.

9. The computer-implemented method of claim 2, further comprising rendering one or more multimedia shows, for each destination and category pair of the destination and category pairs.

10. A computer-readable medium, having stored thereon a plurality of instructions, said plurality of instructions when executed by a computer, cause said computer to perform:
receiving digital content to be used in a multimedia show, the digital content including digital photographs, digital video, and digital music;
determining one or more categories associated with the digital content;
determining one or more cable network destinations available for the multimedia show; and
generating destination and category pairs from the one or more categories and the one or more cable network destinations; and
determining one or more time slots available for the digital content.

11. The computer-readable medium of claim 10, having stored thereon additional instructions, said additional instructions when executed by a computer, cause said computer to further perform:
providing the one or more time slots to a client before rendering the multimedia show; and
receiving a time slot selection from the client.

12. The computer-readable medium of claim 11, having stored thereon additional instructions, said additional instructions when executed by a computer, cause said computer to further perform:
rendering the multimedia show;
notifying a workflow manager that the multimedia show has been rendered;
transmitting the multimedia show to the one or more cable network destinations for transmission on a VOD system, according to the one or more time slots and the one or more categories.

13. The computer-readable medium of claim 12, having stored thereon additional instructions, said additional instructions when executed by a computer, cause said computer to further perform associating a state with the multimedia show, the state being one of pending, on-air, and off-air.

14. The computer-readable medium of claim 10, wherein an XML file includes a title, a menu, a short description, a long description, a length of the multimedia show, a rating, a license window, routing instructions and a location for playing.

15. The computer-readable medium of claim 12, having stored thereon additional instructions, said additional instructions when executed by a computer, cause said computer to further perform queuing the multimedia show for review according to the one or more categories, and the one or more destinations.

16. The computer-readable medium of claim 12, having stored thereon additional instructions, said additional instructions when executed by a computer, cause said computer to further perform providing the multimedia show for availability on the VOD system according to one or more constraints, where the one or more constraints include a cut-off time for approving the multimedia show, a maximum amount of space for the multimedia shows based on time, data size and the number of time slots for playback on the VOD system.

17. The computer-readable medium of claim 11, having stored thereon additional instructions, said additional instructions when executed by a computer, cause said computer to further perform queuing the multimedia show for availability on the VOD system according to one or more constraints, where the one or more constraints include a time window in which the multimedia show may be transmitted to the cable system.

18. The computer-readable medium of claim 11, having stored thereon additional instructions, said additional instructions when executed by a computer, cause said computer to further perform rendering one or more multimedia shows including the multimedia show, for each destination and category pair of the destination and category pairs.
